(19) United States
(12) Patent Application Publication
(10) Pub. No.: US 2008/0007040 A1
(43) Pub. Date: Jan. 10, 2008

(54) HOLDER FOR A BICYCLE

(75) Inventors: Eberhard Maucher, Ulm (DE); Sandro Hans, Berlin (DE); Gerald Hahn, Wistedt (DE)

Correspondence Address: BROOKS KUSHMAN P.C., 1000 TOWN CENTER, TWENTY-SECOND FLOOR, SOUTHFIELD, MI, 48075, US

(73) Assignee: MAGNA CAR TOP SYSTEMS GMBH, Bietigheim-Bissingen (DE)

(21) Appl. No.: 11/770,278

(22) Filed: Jun. 28, 2007

(30) Foreign Application Priority Data
Jul. 8, 2006 (DE) 10 2006 031 691.6

(51) Int. Cl. B60R 9/10; B60R 9/06

(52) U.S. Cl. 280/769

(57) ABSTRACT

A bicycle holder for a vehicle includes a holding element for receiving a crank arm of a pedal of a bicycle when the crank arm is brought into a vertical position and inserted into the holding element. A stop member is operable with the holding element such that a crank arm inserted into the holding element is vertically supported on the stop member. A control element is fixed to the stop member. The control element applies pressure transversely to a crank arm inserted into the holding element. The control element has first and second actuators supported on opposite sides of a crank arm inserted into the holding element. Each of the actuators is vertically movable relative to the holding element.

### CROSS-REFERENCE TO RELATED APPLICATIONS

This application claims foreign priority benefits under 35 U.S.C. §119(a)-(d) to DE 10 2006 031 691.6, filed Jul. 8, 2006, which is hereby incorporated by reference in its entirety.

### BACKGROUND OF THE INVENTION

1. Field of the Invention

The present invention relates to a bicycle holder for a motor vehicle.

2. Background Art

DE 94 20 632 U1 describes a bicycle carrier for use with a vehicle. The carrier has an upright holding element for receiving a crank arm of a pedal of a bicycle. The crank arm rests in a slotted recess in the holding element by a crank pin. The crank arm is guided along a first longitudinal side against a stop on the holding element. An actuator engages with a second longitudinal side of the crank arm. The actuator tensions the crank arm directly against the holding element or tensions a bearing bushing of the crank arm against the holding element with the use of a bolt. The bolt cooperates with a nut fastened to a retainer which is pushed from the top downward over the holding element.

U.S. Pat. No. 5,025,932 describes a bicycle carrier having an upright holding element for receiving a crank arm of a pedal of a bicycle. Pins in a bottom bracket and in the pedal are fixed in slotted recesses in mutually spaced walls of the holding element.

### SUMMARY OF THE INVENTION

An object of the present invention includes a bicycle holder for a vehicle which has a simple design, good functionality, and handling ease. A further aim is to ensure that crank arms having right-angled bends extending transverse to the longitudinal direction of the bicycles, and having different shapes, may be inserted into the holder.

In carrying out the above object and other objects, the present invention provides a bicycle holder for a vehicle. The bicycle holder includes a holding element for receiving a crank arm of a pedal of a bicycle when the crank arm is brought into a vertical position and inserted into the holding element. The bicycle holder further includes a stop member operable with the holding element such that a crank arm inserted into the holding element is vertically supported on the stop member. The bicycle holder further includes a control element fixed to the stop member. The control element applies pressure transversely to a crank arm inserted into the holding element. The control element has first and second actuators supported on opposite sides of a crank arm inserted into the holding element. Each of the actuators is vertically movable relative to the holding element.

In an embodiment, the first actuator is transversely movable relative to the holding element. Alternatively, both actuators are transversely movable relative to the holding element.

In an embodiment, the first actuator includes a support member which is vertically movable relative to the holding element. The support member is supported on an inner side of the holding element and includes a clamping screw which is screwed into a thread in the support member. The support member has a U-shaped profile having first bends at free ends of legs, and the holding element has second bends. The first bends of the support member engage the second bends of the holding element such that the support member is vertically movable relative to the holding element. The clamping screw includes at a first end a rotary handle and at a second end a ball head. The first actuator further includes a ball socket of a pressure plate oriented toward a crank arm inserted into the holding element. The ball head is for cooperating with the ball socket. The first actuator further includes an elastic support element mounted on the pressure plate between the pressure plate and a crank arm inserted into the holding element.

In an embodiment, the second actuator is fixedly mounted on a wall of the holding element. The second actuator includes a rotary handle and an adjustment element which are rotatably supported in a borehole in the wall of the holding element. The adjustment element includes a support element oriented toward a crank arm inserted into the holding element by an axially acting actuating device. The actuating device includes first and second gears between the adjustment element and the support element which produce axial motions.

In an embodiment, the stop member supports a crank arm inserted into the holding element in a direction transverse to the crank arm.

Primary advantages achieved by a bicycle holder in accordance with embodiments of the present invention are that use of the first and second actuators of the control element and the stop member of the holding element of the bicycle holder ensure a proper insertion and a secure placement of a crank arm of the pedal of a bicycle into the holding element. The secure placement of the crank arm into the holding element is of importance with regard to road safety when the bicycle holder is mounted onto a vehicle. The first and second actuators are adjustable in the transverse direction with respect to a crank arm inserted into the holding element thereby allowing crank arms of different configurations to be fixedly received within the holding element. Such different crank arm configurations vary in their right-angle bend according to different designs and models of bicycles. A support member of the first actuator which has a clamping screw represents a simple component which by its first bends cooperates in a targeted manner with second bends of the holding element to be vertically movable relative to the holding element. The second actuator has a simple design and handling ease. The choice of materials of the components of the control element and the stop member which cooperate with a crank arm inserted into the holding element ensures that chrome-plated or mirror-finish surfaces of the crank arm are not marred.

The above features, and other features and advantages of the present invention as readily apparent from the following detailed descriptions thereof when taken in connection with the accompanying drawings.

### BRIEF DESCRIPTION OF THE DRAWINGS

FIG. 1 illustrates a perspective view of a rear end portion of a vehicle having a bicycle holder in accordance with an embodiment of the present invention;

FIG. 2 illustrates an enlarged view of detail X of FIG. 1 with a crank arm of a pedal device of a bicycle inserted into a holding element of the bicycle holder;

FIG. 3 illustrates a first supplementary view corresponding to FIG. 2 of the holding element with the crank arm inserted therein;

FIG. 4 illustrates a second supplementary view corresponding to FIG. 2 of the holding element with the crank arm inserted therein;

FIG. 5 illustrates an enlarged sectional view along line V-V of FIG. 4;

FIG. 6 illustrates a view corresponding to FIG. 2 of the holding element without the crank arm inserted therein;

FIG. 7 illustrates a view corresponding to FIG. 6 of the holding element having a support member of a first actuator of a control element inserted therein;

FIG. 8 illustrates an exploded view of the support member and the first actuator of a control element of the holding element;

FIG. 9 illustrates an exploded view of the second actuator of the control element of the holding element;

FIG. 10 illustrates a view of the second actuator of the control element of the holding element in the direction of arrow Y of FIG. 9;

FIG. 11 illustrates a view of the second actuator of the control element of the holding element in the direction of arrow Z of FIG. 9; and

FIG. 12 illustrates an enlarged view of FIG. 11.

### DETAILED DESCRIPTION OF THE PREFERRED EMBODIMENT(S)

Identical or similar components have the same reference numerals in the figures.

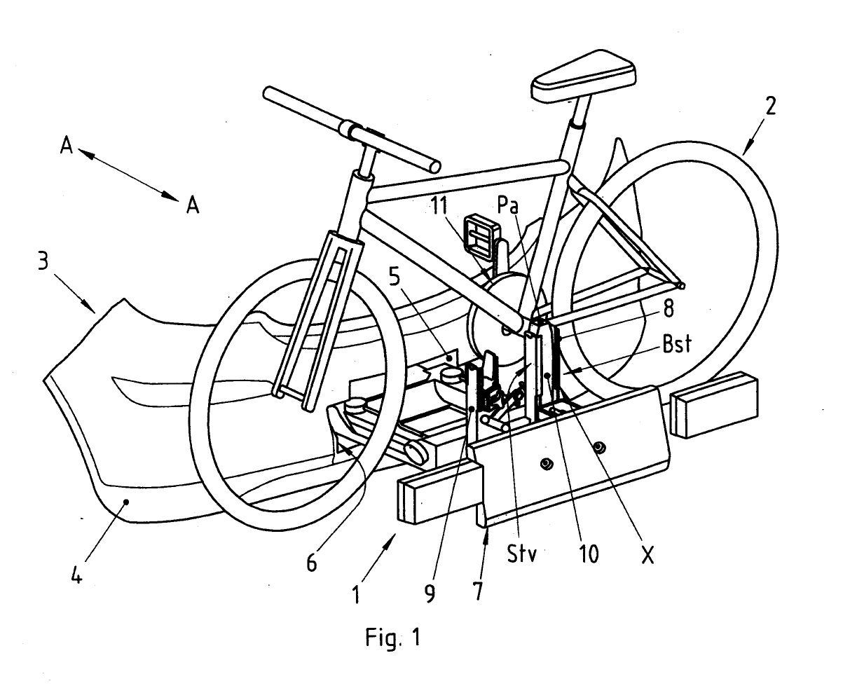

Referring now to FIG. 1, a perspective view of a rear end portion 4 of a vehicle 3 having a bicycle holder 1 in accordance with an embodiment of the present invention is shown. Rear end vehicle portion 4 has an opening 5 running along a central longitudinal plane for receiving an extension of holder 1 in order for holder 1 to be mounted to vehicle 3. Holder 1 is intended for use with vehicle 3 to transport two upright bicycles side-by-side. Each bicycle held on holder 1 extends transversely to longitudinal direction A-A of vehicle 3 (i.e., each bicycle is generally aligned parallel with rear end vehicle portion 4 as shown in FIG. 1).

Holder 1 is movable between a neutral position and an extended operating position Bst. In the neutral position, holder 1 is stored in a storage compartment 6 of vehicle 3. A cover 7 encloses opening 5 when holder 1 is in storage compartment 6. Cover 7 is integrated into the molded structure of rear end vehicle portion 4. In the extended operating position Bst, holder 1 extends out from vehicle 3.

Holder 1 includes first and second holding elements 8, 9. Holding elements 8, 9 are functionally identical and are in the shape of a tubular hollow body. Each holding element 8, 9 is movable (e.g., may swivel) between a horizontal stored position and an upright vertically-orientated operating position Stv. Each holding element 8, 9 is operable to receive and hold a crank arm of a pedal of a respective bicycle when the holding column is in the upright position Stv. FIG. 1 illustrates holding elements 8, 9 in their upright position Stv. FIG. 1 further illustrates first holding element 8 receiving and holding a crank arm 10 of a pedal device 11 of a bicycle 2. Crank arm 10 is moved into an upright position Pa while being inserted in first holding element 8. As such, first holding element 8 receives crank arm 10 as crank arm 10 is inserted from above and downward into first holding element 8. A crank arm of a second bicycle may be introduced into second holding element 9.

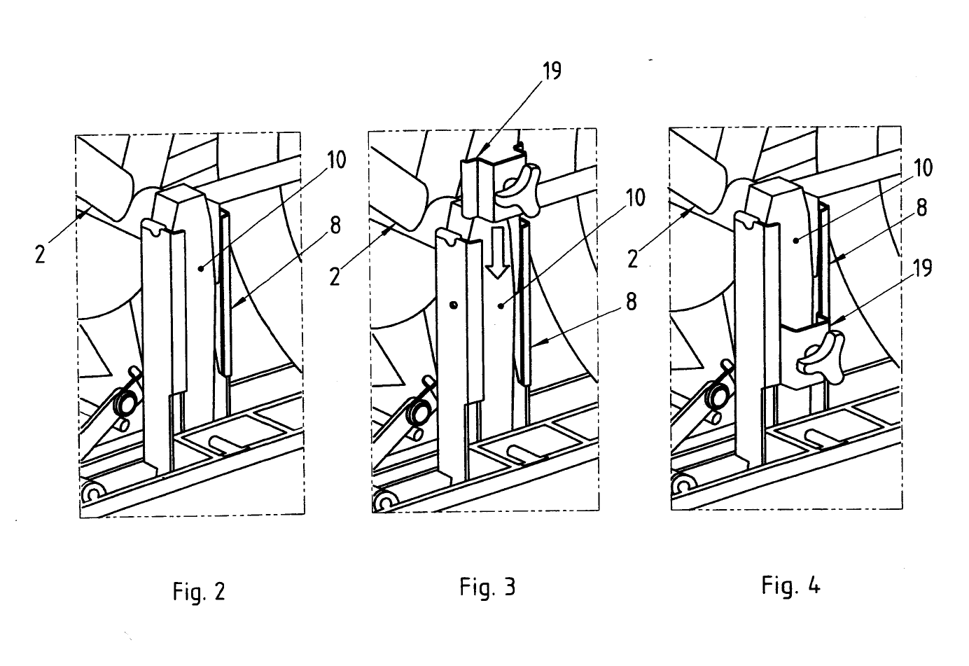

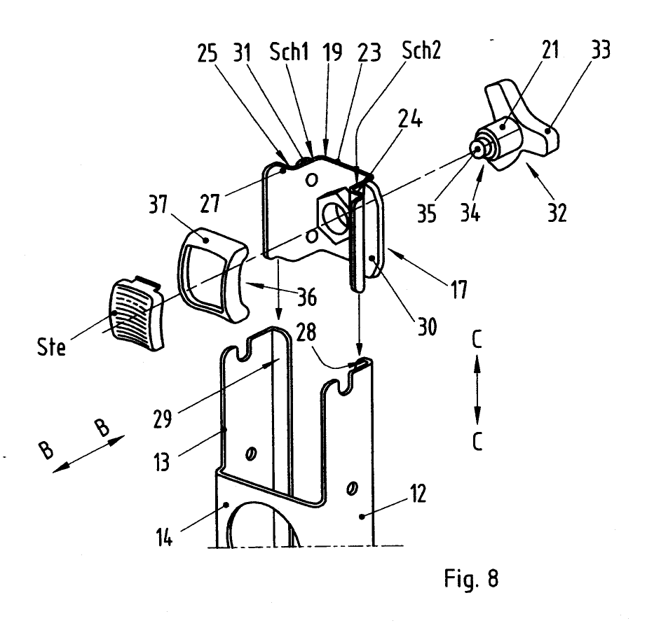

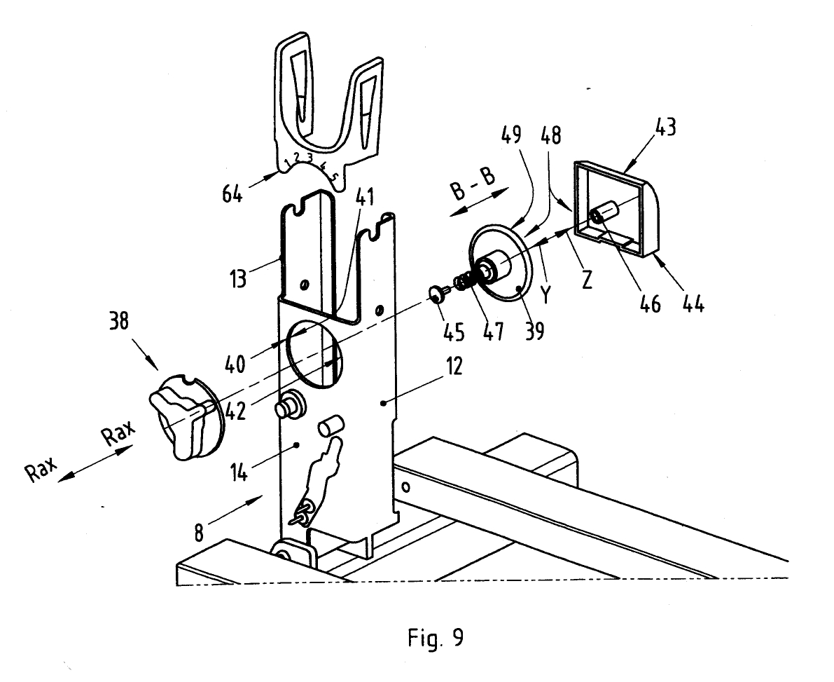

FIG. 2 illustrates an enlarged view of detail X of FIG. 1 with crank arm 10 of pedal device 11 of bicycle 2 inserted into first holding element 8. FIGS. 3 and 4 respectively illustrate first and second supplementary views corresponding to FIG. 2 of first holding element 8 with crank arm 10 inserted therein. Crank arm 10 is partially enclosed by walls 12, 13, and 14 (see FIGS. 8 and 9) of first holding element 8 while inserted into first holding element 8.

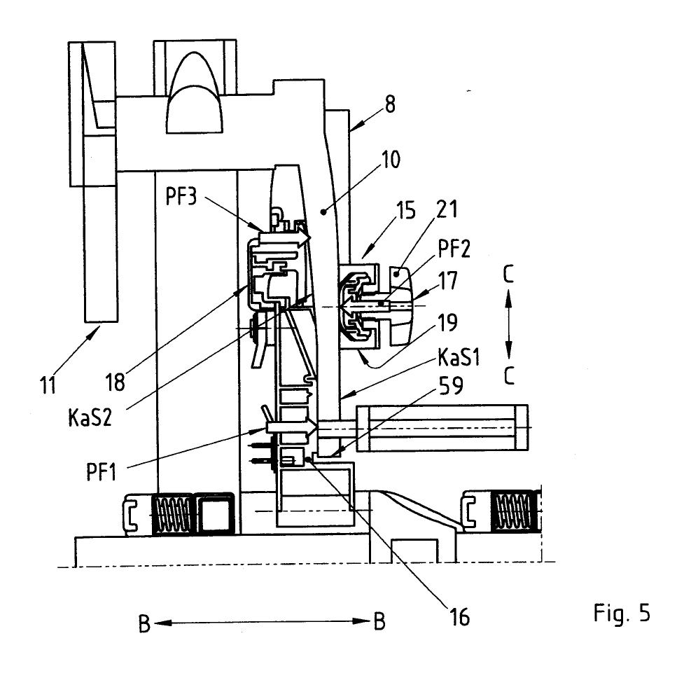

Referring now to FIG. 5, with continual reference to FIGS. 1, 2, 3, and 4, an enlarged sectional view along line V-V of FIG. 4 is shown. FIG. 5 illustrates crank arm 10 inserted into first holding element 8. First holding element 8 includes a control element 15 and a stop member 16. Control element 15 and stop member 16 function to fix crank arm 10 in place within first holding element 8. Crank arm 10 lies against stop member 16 and control element 15 acts in transverse direction B-B with respect to crank arm 10.

Control element 15 includes a first actuator 17 and a second actuator 18. Actuators 17, 18 are supported on opposite sides KaS1 and KaS2 of crank arm 10 with crank arm 10 supported on stop member 16. At least first actuator 17 is movable in vertical direction C-C of first holding element 8 to allow actuators 17, 18 to be vertically aligned relative to one another. In an embodiment, both actuators 17, 18 are movable in transverse direction B-B with respect to crank arm 10 thereby enabling a targeted clamping or fixing of crank arm 10 within first holding element 8. That is, because both actuators 17, 18 are movable in transverse direction B-B with respect to crank arm 10, differently shaped crank arms for different types of bicycles may be clamped or fixed within first holding element 8. The targeted clamping or fixing of correspondingly shaped crank arms for different bicycles is illustrated in FIG. 5 by horizontal, oppositely oriented pointing arrows PF1, PF2, and PF3.

First actuator 17 of control element 15 of first holding element 8 includes a movable support member 19. Support member 19 is movable in vertical direction C-C of first holding element 8. A clamping screw 21 supports support member 19 on an inner side of first holding element 8. Clamping screw 21 is screwed into a thread in support member 19.

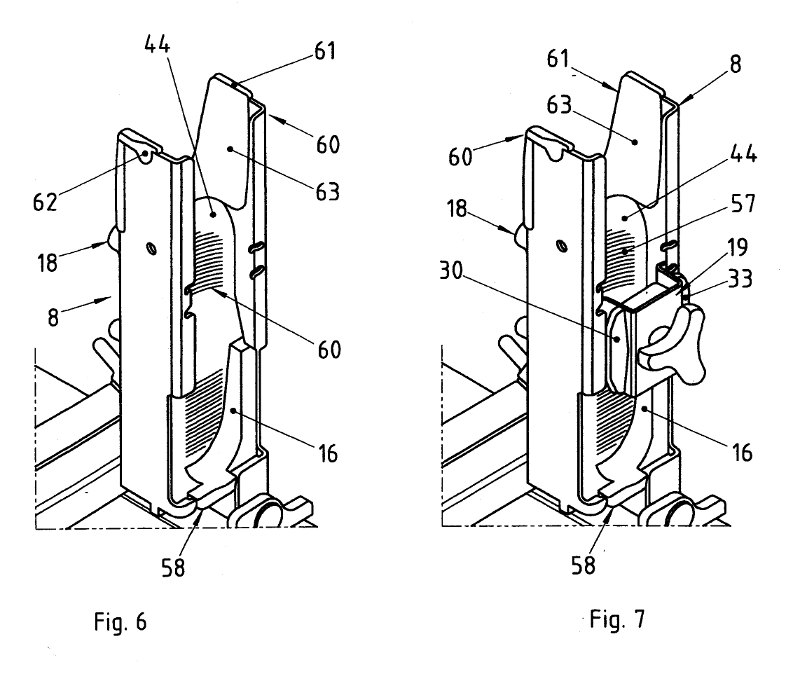

FIG. 6 illustrates a view corresponding to FIG. 2 of first holding element 8 without crank arm 10 inserted therein. FIG. 7 illustrates a view corresponding to FIG. 6 of first holding element 8 having support member 19 of first actuator 17 of control element 15 inserted therein.

FIG. 8 illustrates an exploded view of support member 19 and first actuator 17 of control element 15 of first holding element 8.

Support member 19 has a U-shaped profile 23 having first bends 27 at free ends 24, 25 of legs Sch1 and Sch2. First bends 27 of support member 19 engage behind respective second bends 28, 29 of walls 12, 13 of first holding element 8. Guide elements 30, 31 of support member 19 are at a distance from first bends 27 of support member 19. Guide elements 30, 31 facilitate guiding support member 19 along second bends 28, 29 of walls 12, 13 of first holding element 8.

Clamping screw 31 includes a first rotary handle 33 at its first end 32. Clamping screw 31 includes a ball head 35 at its second end 34. Ball head 35 is for a ball socket 36 of a pressure plate 37 orientated toward crank arm 10 when crank arm 10 is inserted into first holding element 8. An elastic support element Ste is between crank arm 10 and pressure plate 37 and is held in place on pressure plate 37.

Referring now to FIG. 9, with continual reference to the preceding FIGS., an exploded view of second actuator 18 of control element 15 of first holding element 8 is shown. Second actuator 19 is situated on wall 14 of first holding element 8. Second actuator 19 includes a second rotary handle 38 and an adjustment element 39. Rotary handle 38 and adjustment element 39 have a rotationally symmetrical shape. Rotary handle 38 and adjustment element 39 are connected to one another by a clip connection acting in the axial direction Rax-Rax. Rotary handle 38 and adjustment element 39 combine into a single component when connected to one another. The single component of rotary handle 38 and adjustment element 39 border an outer side 40 and an inner side 41 of wall 14. The single component is supported in a borehole 42 in wall 14.

Adjustment element 39 bears a support element 44 on its side 43 facing crank arm 10. Adjustment element 39 is connected to support element 44 via an axial screw 45 in mechanical linkage with threaded pins 46 of support element 44. A compression spring 47 and an actuating device 48 act between adjustment element 39 and support element 44. Support element 44 may be axially displaced in transverse direction B-B by actuating device 48.

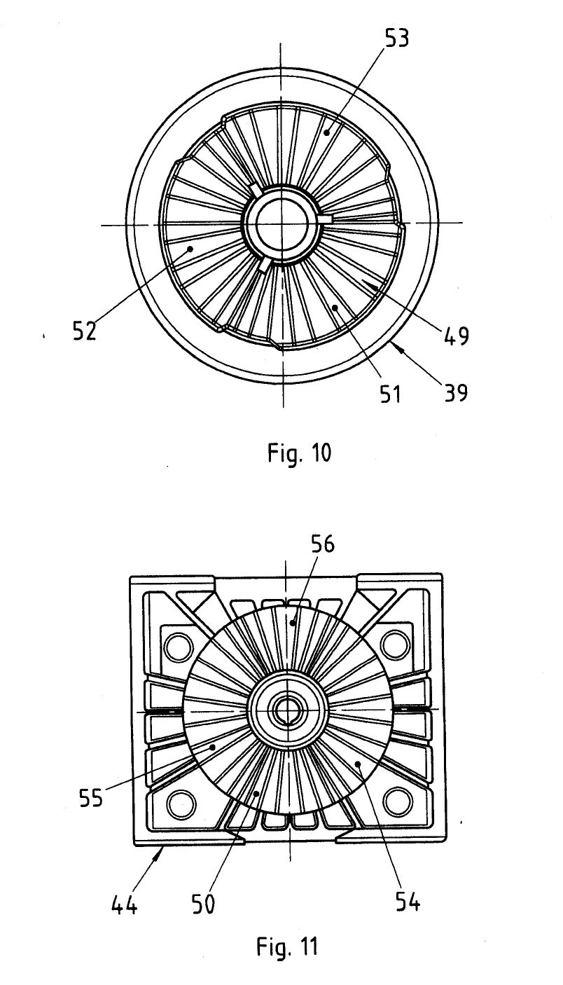

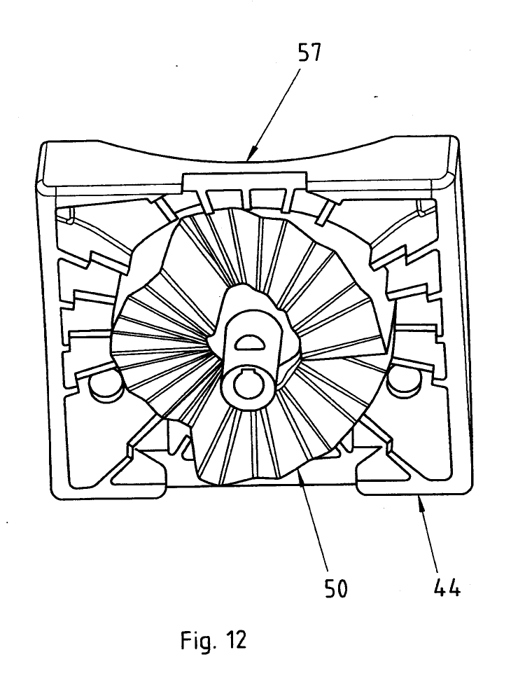

FIG. 10 illustrates a view of second actuator 19 of control element 15 of first holding element 8 in the direction of arrow Y of FIG. 9. FIG. 11 illustrates a view of second actuator 19 in the direction of arrow Z of FIG. 9. FIG. 12 illustrates an enlarged view of FIG. 11.

Actuating device 48 includes a first toothed gearing 49 on adjustment element 39 (see FIG. 10) and a second toothed gearing 50 on support element 44 (see FIGS. 11 and 12). Gears 49, 50 mutually face one another. Gears 49, 50 are designed such that the position of second actuator 18 is maintained once it is set even when subjected to vibrations of vehicle 3 during operation. First gear 49 has three geared sections 51, 52, 53 uniformly distributed over the circumference of adjustment element 39 (see FIG. 10). Likewise, second gear 50 has three geared sections 54, 55, 56 uniformly distributed over the circumference of support element 44 (see FIG. 11). To ensure that crank arm 10 of bicycle 2 is properly (i.e., centrally) accommodated by support element 44, support element 44 is flexible and has a concave design on its side 57 facing crank arm 10.

Referring back now to FIGS. 5, 6, and 7, with continual reference to the other FIGS., stop member 16 of first holding element 8 functions as a first insert 58 for first holding element 8. Stop member 16 is made of an elastic material for this purpose. First insert 58 supports crank arm 10 in transverse direction B-B as well as on a free end 59 of crank arm 10 (see FIG. 5). An upper end 60 of first insert 58 prevents rotation of support element 44 of second actuator 18.

A second insert 61 of first holding element 8 is mounted on the free upper end of first holding element 8. Second insert 61 is constructed of a flexible material such that it provides protection from damage to high-quality painted or chrome-plated surfaces of bicycle 2. Second insert 61 is held in position in first holding element 8 by engaging holding devices 62 (acting in a form-fit manner) and elastic tabs 63 (acting in a friction-fit manner). Lastly, on the side facing second rotary handle 38, second insert 61 includes a scale 64 (see FIG. 9). Scale 64 is used for targeted adjustment of second actuator 18.

While embodiments of the present invention have been illustrated and described, it is not intended that these embodiments illustrate and describe all possible forms of the present invention. Rather, the words used in the specification are words of description rather than limitation, and it is understood that various changes may be made without departing from the spirit and scope of the present invention.

What is claimed is:

1. A bicycle holder for a vehicle, the bicycle holder comprising:
a holding element for receiving a crank arm of a pedal of a bicycle when the crank arm is brought into a vertical position and inserted into the holding element;
a stop member operable with the holding element such that a crank arm inserted into the holding element is vertically supported on the stop member; and
a control element fixed to the stop member, the control element applying pressure transversely to a crank arm inserted into the holding element, wherein the control element has first and second actuators supported on opposite sides of a crank arm inserted into the holding element, wherein each of the actuators is vertically movable relative to the holding element.

2. The bicycle holder of claim 1 wherein:
the first actuator is transversely movable relative to the holding element.

3. The bicycle holder of claim 1 wherein:
both actuators are transversely movable relative to the holding element.

4. The bicycle holder of claim 1 wherein:
the first actuator includes a support member which is vertically movable relative to the holding element, wherein the support member is supported on an inner side of the holding element and includes a clamping screw which is screwed into a thread in the support member.

5. The bicycle holder of claim 4 wherein:
the support member has a U-shaped profile having first bends at free ends of legs,
wherein the holding element has second bends;
wherein the first bends of the support member engage the second bends of the holding element such that the support member is vertically movable relative to the holding element.

6. The bicycle holder of claim 5 wherein:
the support member includes guide elements positioned at a distance from the second bends of the holding element.

7. The bicycle holder of claim 4 wherein:
the clamping screw includes at a first end a rotary handle and at a second end a ball head;
wherein the first actuator further includes a ball socket of a pressure plate oriented toward a crank arm inserted into the holding element;
wherein the ball head is for cooperating with the ball socket.

8. The bicycle holder of claim 7 wherein:
the first actuator further includes an elastic support element mounted on the pressure plate between the pressure plate and a crank arm inserted into the holding element.

9. The bicycle holder of claim 1 wherein:
the second actuator is fixedly mounted on a wall of the holding element.

10. The bicycle holder of claim 9 wherein:
the second actuator includes a rotary handle and an adjustment element which are rotatably supported in a borehole in the wall of the holding element.

11. The bicycle holder of claim 10 wherein:
the adjustment element includes a support element oriented toward a crank arm inserted into the holding element by an axially acting actuating device.

12. The bicycle holder of claim 11 wherein:
the actuating device includes first and second gears between the adjustment element and the support element which produce axial motions.

13. The bicycle holder of claim 11 wherein:
the support element is of a flexible material.

14. The bicycle holder of claim 1 wherein:
the stop member supports a crank arm inserted into the holding element in a direction transverse to the crank arm.

15. The bicycle holder of claim 1 wherein:
the stop member includes a first insert integrated with the holding element.

16. The bicycle holder of claim 1 wherein:
the holding element at a free upper end includes a second insert.

17. The bicycle holder of claim 16 wherein:
the second insert is held in position in the holding element in either a form-fit or friction-fit manner.
